(19) United States
(12) Patent Application Publication
(10) Pub. No.: US 2016/0061670 A1
(43) Pub. Date: Mar. 3, 2016

(54) LOAD DETECTOR

(71) Applicant: PANASONIC INTELLECTUAL PROPERTY MANAGEMENT CO., LTD., Osaka-shi, Osaka (JP)

(72) Inventors: MASAHIKO OHBAYASHI, Osaka (JP); KOUICHI ABURATA, Fukui (JP); TAKAAKI OGAWA, Fukui (JP); KAZUHIRO NOMURA, Fukui (JP)

(21) Appl. No.: 14/786,873

(22) PCT Filed: May 13, 2014
(86) PCT No.: PCT/JP2014/002509

§ 371 Date: Oct. 23, 2015

(30) Foreign Application Priority Data
May 21, 2013 (JP) 2013-106876

(51) Int. Cl. G01L 1/22

(52) U.S. Cl. CPC G01L 1/22

(57) ABSTRACT

A load detecting device has a deformable body, a strain detection element disposed on the deformable body, and an adhesive layer located between the deformable body and the strain detection element and fixing the strain detection element to the deformable body. The adhesive layer is formed of a glass adhesive. The load detecting device has high productivity.

### TECHNICAL FIELD

The present invention relates to a load detecting device for detecting a load applied to a deformable body by measuring mechanical strain caused in the deformable body.

### BACKGROUND ART

FIG. 9 is a plan view of a deformable body of a conventional load detecting device. Deformable body 111 is a stainless steel plate having a glass layer formed thereon. Deformable body 111 has detecting hole 112 in the substantially center thereof. On a surface of deformable body 111, power supply electrode 116, GND electrode 117, output electrode 118, and circuit pattern 121 are formed. Each of them is made of a conductor. Further, compressive strain resistor element 119 and tensile strain resistor element 120 are formed on the surface of deformable body 111. Compressive strain resistor element 119 and tensile strain resistor element 120 are obtained by sintering metal glaze paste which is formed by printing.

In the conventional load detecting device, resistance values of compressive strain resistor element 119 and tensile strain resistor element 120 vary depending on strain of deformable body 111 that has received a load, and a voltage of output electrode 118 also varies. Thus, the voltage of output electrode 118 is measured to detect the load.

The conventional load detecting device is described in Patent Literature 1.

As another conventional load detecting device, the configuration constituted by a deformable body and a strain gage attached to the deformable body is known, and is described in Patent Literature 2. A strain gage is typically covered with a resin film to ensure insulation properties, and bonded to a deformable body with a resin adhesive.

### CITATION LIST

### Patent Literatures

PLT 1: Unexamined Japanese Patent Publication No. 2007-127580

PLT 2: Unexamined Japanese Patent Publication No. 2008-134232

### SUMMARY OF THE INVENTION

A load detecting device has a deformable body, a strain detecting element disposed on the deformable body, an adhesive layer located between the deformable body and the strain detecting element and fixing the strain detecting element to the deformable body. The adhesive layer is formed of a glass adhesive.

### BRIEF DESCRIPTION OF THE DRAWINGS

FIG. 1 is an exploded perspective view of a load detecting device according to an embodiment of the present invention.

FIG. 2 is a schematic view of a cross-section of each of strain resistor elements according to the embodiment.

FIG. 3 is a top view of each of the strain resistor elements according to the embodiment.

FIG. 4 is a view showing an arrangement of the strain resistor elements on the deformable body according to the embodiment.

FIG. 5 is a circuit diagram of the load detecting device according to the embodiment.

FIG. 6 is a manufacturing process view of the strain resistor elements according to the embodiment.

FIG. 7 is a schematic view showing a situation at detecting a load by the load detecting device according to the embodiment.

FIG. 8 is a view showing simulation results of the load detecting device.

FIG. 9 is a plan view of a deformable body of a conventional load detecting device.

### DETAILED DESCRIPTION OF PREFERRED EMBODIMENT

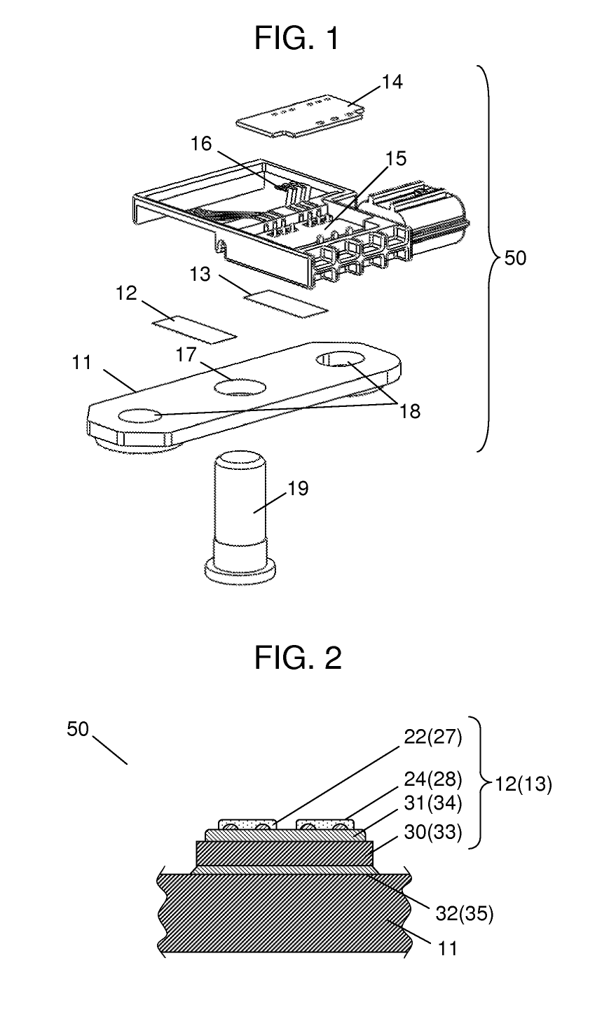

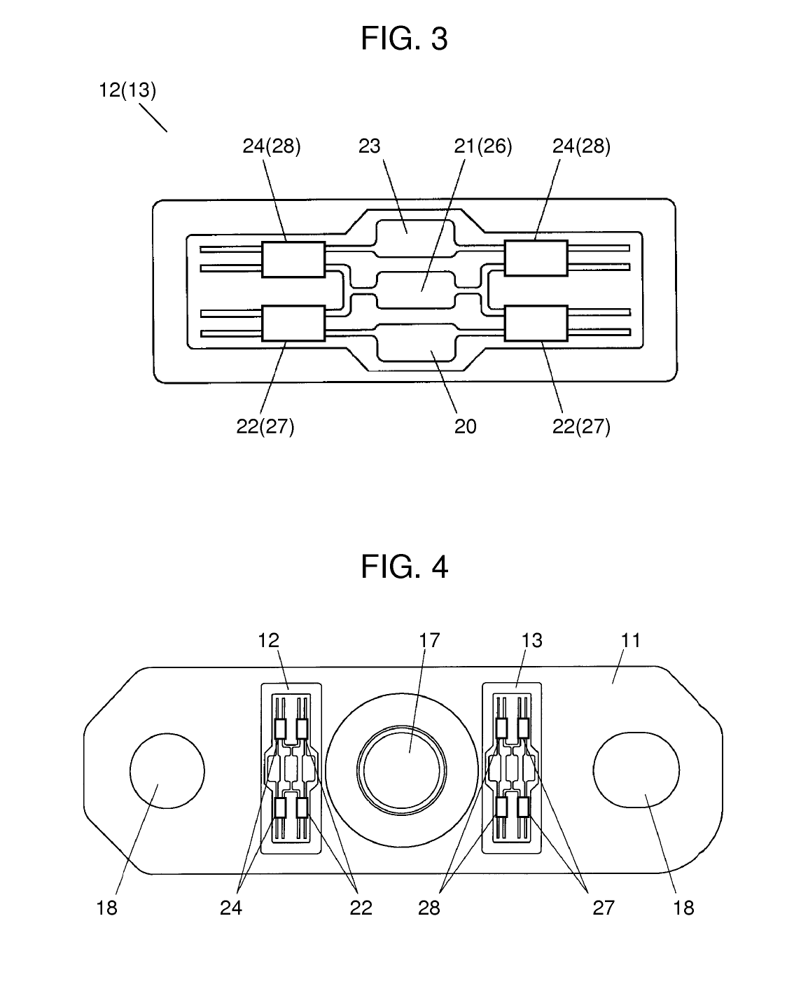

FIG. 1 is an exploded perspective view of load detecting device 50 according to an embodiment. FIG. 2 and FIG. 3 are a schematic view of a cross-section and a top view of each of strain resistor elements 12, 13 according to the embodiment, respectively.

Load detecting device 50 has deformable body 11, strain resistor elements 12, 13, and adhesive layers 32, 35. Deformable body 11 deforms upon receiving a load. Deformable body 11 has three through-holes 17, 18. Through-hole 17 is provided in the center of deformable body 11. Two through-holes 18 are provided in both end portions of deformable body 11, respectively. Pressing member 19 for transmitting a detection load is inserted into through-hole 17. Fixing members for external mounting (not specifically shown) are inserted into two through-holes 18.

Strain resistor element 12 is a strain detection element. When strain resistor element 12 deforms, the resistance value changes. Strain resistor element 12 is disposed on a surface of deformable body 11. Adhesive layer 32 is located between deformable body 11 and strain resistor element 12 to fix strain resistor element 12 to deformable body 11.

Strain resistor element 13 is, like strain resistor element 12, also a strain detection element, and disposed on the surface of deformable body 11. Adhesive layer 35 is located between deformable body 11 and strain resistor element 13 to fix strain resistor element 13 to deformable body 11.

Load detecting device 50 further has control circuit 14, connector case 15, and wiring electrodes 16. Connector case 15 houses control circuit 14. Connector case 15 is attached to deformable body 11. Wiring electrodes 16 electrically connect strain resistor elements 12, 13 to control circuit 14.

As shown in FIG. 2 and FIG. 3, strain resistor element 12 has supporting substrate 30, insulating layer 31, power supply terminal 20, output terminal 21, thick-film resistor patterns 22, ground terminal 23, and thick-film resistor patterns 24. Supporting substrate 30 is made of metal and has flexibility. Insulating layer 31 is provided on a surface of supporting substrate 30. Power supply terminal 20, output terminal 21, ground terminal 23, and thick-film resistor patterns 22, 24 are formed on insulating layer 31.

Strain resistor element 13, like strain resistor element 12, has supporting substrate 33, insulating layer 34, power supply terminal 20, output terminal 26, thick-film resistor patterns 27, ground terminal 23, and thick-film resistor patterns 28. Supporting substrate 33 is made of metal and has flexibility. Insulating layer 34 is provided on a surface of supporting substrate 33. Power supply terminal 20, output terminal 26, ground terminal 23, and thick-film resistor patterns 27, 28 are formed on insulating layer 34.

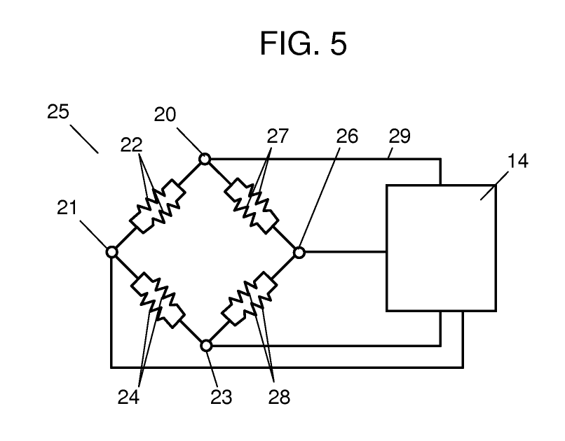

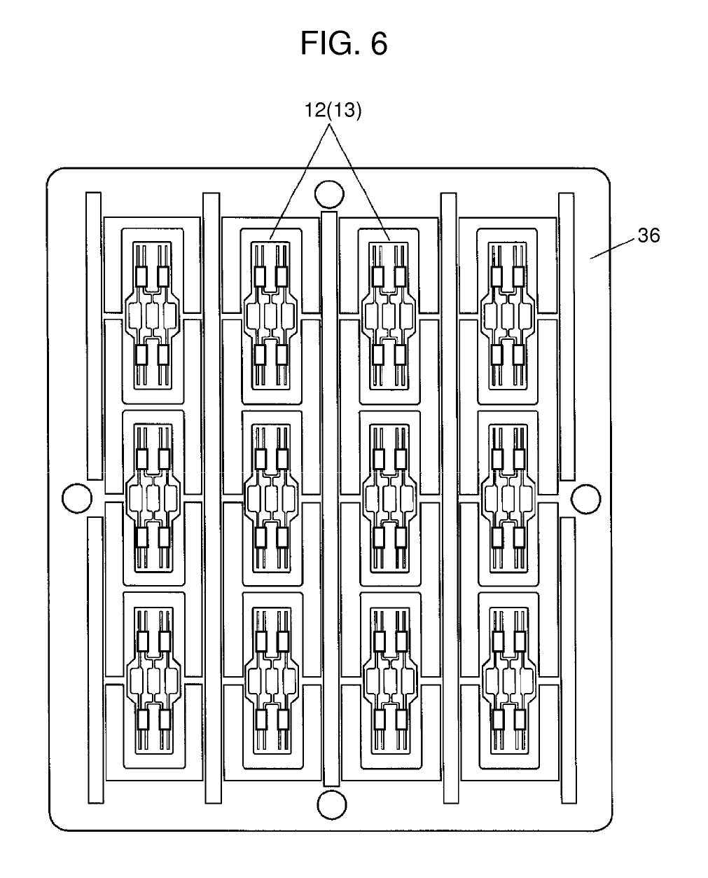

FIG. 4 is a view showing an arrangement of strain resistor elements 12, 13 on deformable body 11 in the embodiment. FIG. 5 is a circuit diagram of load detecting device 50 in the embodiment.

Strain resistor element 12 constitutes half-bridge circuit 25 by using thick-film resistor patterns 22 connected to each other in parallel between power supply terminal 20 and output terminal 21, and thick-film resistor patterns 24 connected to each other in parallel between output terminal 21 and ground terminal 23.

Strain resistor element 13 constitutes half-bridge circuit 29 by using thick-film resistor patterns 27 connected to each other in parallel between power supply terminal 20 and output terminal 26, and thick-film resistor patterns 28 connected to each other in parallel between output terminal 26 and ground terminal 23.

Respective power supply terminals 20 of strain resistor element 12 and strain resistor element 13 have the same electrical potential, whereby those terminals are considered as an identical terminal in the circuit diagram. Likewise, respective ground terminals 23 of strain resistor element 12 and strain resistor element 13 have the same electrical potential, whereby those terminals are considered as an identical terminal in the circuit diagram. Strain resistor element 12 and strain resistor element 13 are combined to constitute a full-bridge circuit.

Control circuit 14 is electrically connected to power supply terminal 20, output terminals 21, 26, and ground terminal 23 via wiring electrodes 16.

FIG. 6 shows strain resistor elements 12, 13 in a manufacturing process according to the embodiment. A sheet of stainless steel plate 36 includes multiple supporting substrates 30, 33. Insulating layer 31, power supply terminal 20, output terminal 21, thick-film resistor patterns 22, ground terminal 23, and thick-film resistor patterns 24 are formed on each of multiple supporting substrates 30. Likewise, power supply terminal 20, ground terminal 23, output terminal 26, thick-film resistor patterns 27, and thick-film resistor patterns 28 are formed on each of multiple supporting substrates 33.

A specific manufacturing method is as follows. Firstly, a large scaled sheet of stainless steel plate 36 is prepared, and glass paste is printed on the top surface of stainless steel plate 36 to form insulating layers 31, 34. Secondly, metal glaze paste is printed on the top surface of insulating layers 31, 34 to form thick-film resistor patterns 22, 24, 27, 28. In the meanwhile, conductive paste is applied to form power supply terminal 20, output terminals 21, 26, and ground terminal 23. Thereafter, the large scaled sheet of stainless steel plate 36 is divided into pieces to produce strain resistor elements 12, 13.

In this manufacturing method, multiple strain resistor elements 12, 13 are produced from the large scaled sheet of stainless steel plate 36 by using printing process. In the printing process, many strain resistor elements 12, 13 are preferably produced in a time to achieve high production efficiency. For miniaturization, deformable body 11 is restricted due to its attachment manner or the like; however, strain resistor elements 12, 13 have no such restrictions. More strain resistor elements 12, 13 can be obtained by producing strain resistor elements 12, 13 from stainless steel plate 36 than by producing deformable body 11 having strain resistor elements 12, 13 formed thereon from stainless steel plate 36 by forming strain resistor elements 12, 13 on deformable body 11 directly.

Accordingly, bonding strain resistor elements 12, 13 to deformable body 11, like load detecting device 50 of the embodiment, is more preferable to achieve high productivity, as compared with the manner where compressive strain resistor element 119 and tensile strain resistor element 120 are directly formed on deformable body 111 like Patent Literature 1 of the conventional art.

Load detecting device 50 of the above configuration operates as follows.

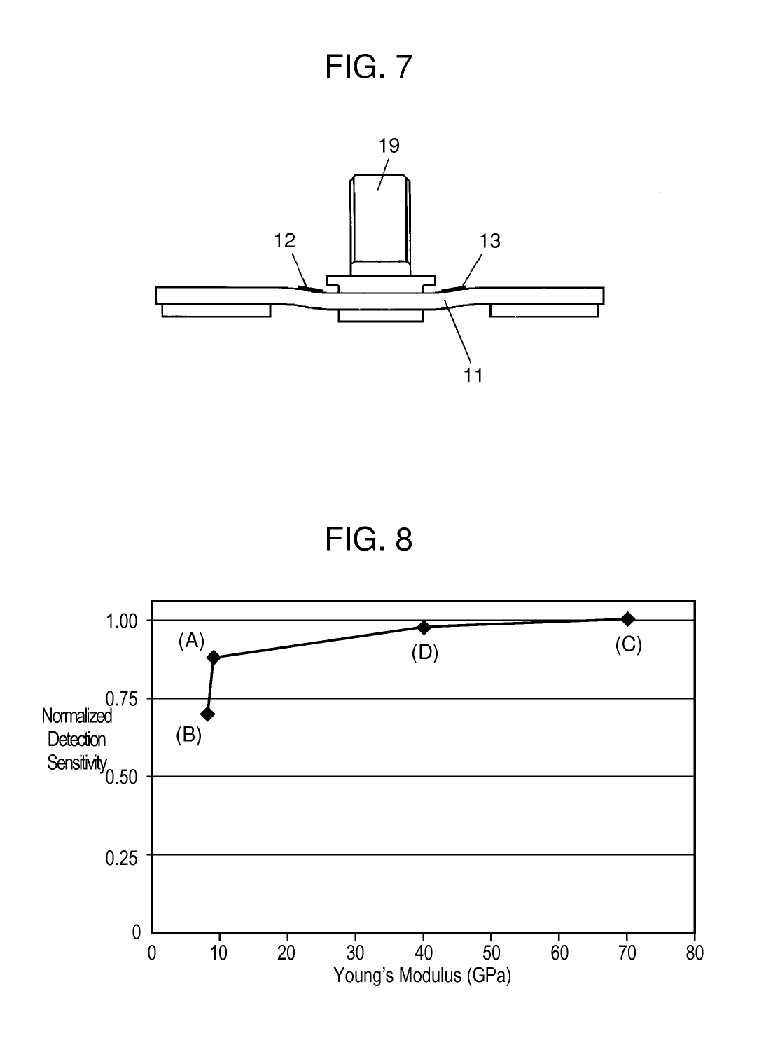

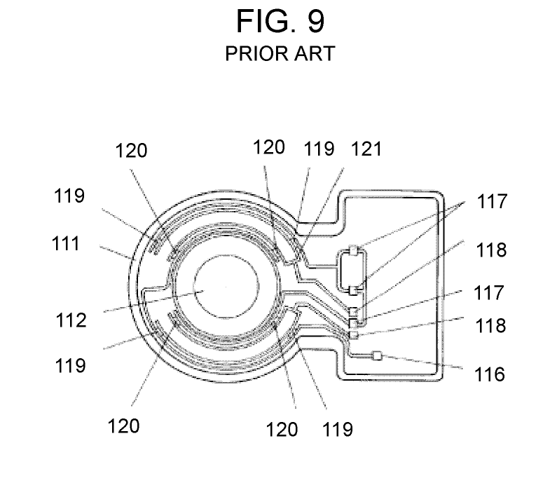

FIG. 7 is a schematic view showing a situation of detecting a load of load detecting device 50 according to the embodiment.

Load detecting device 50, not specifically shown, is attached to a portion between a vehicle seat (not shown) and a seat rail (not shown) as an example, and is used for measuring a load of an occupant who sits on the vehicle seat. In this usage, fixing members (not shown) provided in the seat rail are inserted into through-holes 18 provided on both end sides of deformable body 11, and load detecting device 50 is fixed to the seat rail. Pressing member 19 is inserted into through-hole 17 provided in the center of deformable body 11. A tip end side of pressing member 19 is fixed to a lower portion of the vehicle seat. When a load is applied to the vehicle seat, the load is transmitted to deformable body 11 via pressing member 19, and a center portion of deformable body 11 whose both ends are supported by the fixing members (not shown) deforms downward as shown in FIG. 7. This deformation changes the resistance values of strain resistor elements 12, 13. Control circuit 14 deals with the change in resistance value electrically, whereby a detection signal corresponding to the load is generated.

Hereinafter, more specified description will be made. When the detection load is applied to pressing member 19, the center portion of deformable body 11 deforms downward. At this time, compressive stress acts on thick-film resistor patterns 22, 28 disposed on a through-hole 17 side, and the resistance values of thick-film resistor patterns 22, 28 decrease. Further, tensile stress acts on thick-film resistor patterns 24, 27 disposed on a through-hole 18 side, and the resistance values of thick-film resistor patterns 24, 27 increase. Accordingly, in load detecting device 50, control circuit 14 conducts differential processing of the signals outputted from output terminals 21, 26, thereby generating detection signals according to the amplitude of the detection load.

Deformable body 11 of load detecting device 50 is made of carbon steel, and supporting substrates 30, 33 are made of stainless steel according to the embodiment. If thermal expansion coefficients of adhesive layers 32, 35 for bonding deformable body 11 and supporting substrates 30, 33 are extremely different from a thermal expansion coefficient of deformable body 11 or thermal expansion coefficients of supporting substrates 30, 33, cracks may occur in adhesive layers 32, 35 and cause delamination between deformable body 11 and supporting substrates 30, 33. Therefore, an adhesive material used for adhesive layer 32 is desired to have a similar thermal expansion coefficient to those of deformable body 11 and supporting substrates 30, 33. This ensures adhesive strength between deformable body 11 and supporting substrates 30, 33. Specifically, a glass adhesive is selected to ensure the adhesive strength because the difference between the thermal expansion coefficients of deformable body 11 and supporting substrates 30, 33 and the thermal expansion coefficients of adhesive layers 32, 35 is within 4 ppm/K. The glass adhesive is a glass-based material such as liquid glass (aqueous solution of sodium silicate).

For instance, in the case where supporting substrates 30, 33 made of stainless steel and having a thermal expansion coefficient of 11.5 ppm/K are bonded to deformable body 11 made of carbon steel and having a thermal expansion coefficient of 10.3 ppm/K, the glass adhesive is selected to have thermal expansion coefficients ranging from 6.3 ppm/k to 10.3 ppm/k as adhesive layers 32, 35, thereby securing adhesive strength.

Furthermore, it is effective that an upper limit of the thermal expansion coefficients of adhesive layers 32, 35 is determined to be larger than the smallest value of the thermal expansion coefficients of deformable body 11 and supporting substrates 30, 33 by 4 ppm/K, and a lower limit of the thermal expansion coefficients of adhesive layers 32, 35 is determined to be smaller than the largest value of the thermal expansion coefficients of deformable body 11 and supporting substrates 30, 33 by 4 ppm/K. Thus, the thermal expansion coefficients of adhesive layers 32, 35 have a difference within 4 ppm/K with respect to either of the thermal expansion coefficients of deformable body 11 and supporting substrates 30, 33. This ensures adhesive strength with respect to either of deformable body 11 and supporting substrates 30, 33. For instance, under the condition where deformable body 11 has a thermal expansion coefficient of 10.3 ppm/K and supporting substrates 30, 33 have a thermal expansion coefficient of 11.5 ppm/K, deformable body 11 and supporting substrates 30, 33 are bonded more tightly when a glass adhesive having thermal expansion coefficients in a range from 7.5 ppm/K to 14.3 ppm/K is used as adhesive layers 32, 35.

When the glass adhesive is used as adhesive layers 2, 35, Young's moduli of adhesive layers 32, 35 become larger than those of a resin-based adhesive. As a result, when a deformation is caused in deformable body 11 by the load to be detected and the deformation is transmitted to supporting substrates 30, 33, a loss of the transmission due to adhesive layers 32, 35 is reduced. This increases detection sensitivity of strain resistor elements 12, 13 with respect to the deformation of deformable body 11. As the detection sensitivity increases, resolution of the measurement is improved. When the resolution is improved, a load can be detected accurately even if a deformation of deformable body 11 with respect to the load is small. Thus, deformable body 11 can be designed to decrease a deformation with respect to a load, thereby resulting in miniaturization of load detecting device 50.

FIG. 8 shows simulation results of load detecting device 50 according to the embodiment. The horizontal axis of FIG. 8 indicates Young's modulus of the adhesive bonding deformable body 11 and supporting substrate 30, and the vertical axis indicates detection sensitivity normalized such that the detection sensitivity of strain resistor elements 12, 13 when a glass adhesive is used is 1. The results of FIG. 8 are obtained through simulation.

FIG. 8 indicates detection sensitivities in cases that (A) an epoxy-based adhesive at 25° C. is used as a resin-based adhesive, (B) the epoxy-based adhesive is used at 85° C., and (C) the glass adhesive according to the embodiment is used. Furthermore, other than these materials, FIG. 8 also indicates detection sensitivity in a case that (D) a material having a Young's modulus of 40 GPa, which is not specified, is used. Note that, the Young's modulus in the case (A) is 9 GPa, the Young's modulus in the case (B) is 8 GPa, and the Young's modulus in the case (C) is 70 GPa.

As shown in FIG. 8, the higher the Young's moduli of the adhesives are, the more effectively a deformation from deformable body 11 is transmitted to strain resistor element 12, 13. The detection sensitivity of strain resistor elements 12, 13 increases as the Young's modulus increases. Normalized detection sensitivity of strain resistor elements 12, 13 is approximately 0.87 when the material of (A) is used, and is approximately 0.77 when the material of (B) is used. This shows that the detection sensitivity changes largely when adhesive layer 32 has a Young's modulus of 10 GPa or less.

Furthermore, in the case where deformable body 11 and supporting substrate 30 are bonded by using the epoxy-based adhesive, the detection sensitivity changes largely when temperature of use environments changes, thereby reducing detection accuracy of load detecting device 50. On the contrary, in the case where adhesive layers 32, 35 are formed by using the glass adhesive as in the embodiment, temperature dependence of Young's modulus of the glass adhesive is so small, so that a change in detection sensitivity is small even if temperature of use environments around load detecting device 50 changes. When adhesive layers 32, 35 are formed by using the glass adhesive, detection accuracy of load detecting device 50 can be improved.

A deformation of deformable body 11 is influenced by the size of deformable body 11. As the length of deformable body 11 is longer, the width is narrower, and the thickness is thinner, the deformation increases when a load is applied. As shown in FIG. 8, the detection sensitivity of adhesive layers 32, 35 formed of the glass adhesive indicated by (C) is about 1.3 times as large as the detection sensitivity of adhesive layers 32, 35 formed of the epoxy-based adhesive indicated by (B). Accordingly, as compared with the case where the epoxy-based adhesive is used, even if the deformation of deformable body 11 decreases to 1/1.3, the use of the glass adhesive may obtain the same detection sensitivity as the use of the epoxy-based resin. Therefore, even if a deformation of deformable body 11 decreases to 1/1.3 times the deformation when the epoxy-based adhesive is used, the use of the glass adhesive for bonding deformable body 11 and supporting substrate 30 can obtain the same detection sensitivity as the use of the epoxy-based resin. Thus, load detecting device 50 can be miniaturized.

It is noted that in the embodiment, deformable body 11 is made of carbon steel and supporting substrates 30, 33 are made of stainless steel, but not limited to this example. As long as a thermal expansion coefficient of an adhesive has a difference within 4 ppm/K with respect to thermal expansion coefficient of deformable body 11 or thermal expansion coefficients of supporting substrates 30, 33, the same effect as the embodiment will be obtained. It is particularly useful to form supporting substrates 30, 33 by using metal materials because the difference between the thermal expansion coefficients of supporting substrates 30, 33 and the thermal expansion coefficient of the glass adhesive is not so large.

### INDUSTRIAL APPLICABILITY

The load detecting device in accordance with the present invention relates to a load detecting device for detecting a load applied to a deformable body, and especially is useful in the load detecting device for measuring a load from a vehicle seat.

### REFERENCE MARKS IN THE DRAWINGS

11 deformable body

12, 13 strain resistor element

14 control circuit

15 connector case

16 wiring electrode

17 through-hole

18 through-hole

19 pressing member

20 power supply terminal

21, 26 output terminal

22, 24, 27, 28 thick-film resistor pattern

23 ground terminal

25, 29 half-bridge circuit

30, 33 supporting substrate

31, 34 insulating layer

32, 35 adhesive layer

36 stainless steel plate

50 load detecting device

111 deformable body

112 detecting hole

116 power supply electrode

117 GND electrode

118 output electrode

119 compressive strain resistor element

120 tensile strain resistor element

121 circuit pattern

1. A load detecting device comprising:
a deformable body;
a strain detection element disposed on the deformable body; and
an adhesive layer formed of a glass adhesive, located between the deformable body and the strain detection element, and fixing the strain detection element to the deformable body.

2. The load detecting device according to claim 1,
wherein the deformable body is made of metal,
wherein the strain detection element has:
a supporting substrate made of flexible metal;
a insulating layer disposed on a surface of the supporting substrate; and
a resistor pattern formed on a surface of the insulating layer, and
wherein the adhesive layer is located between the deformable body and the supporting substrate.

3. The load detecting device according to claim 2,
wherein a difference between a thermal expansion coefficient of the supporting substrate and a thermal expansion coefficient of the adhesive layer is 4.0 ppm/K or less.

4. The load detecting device according to claim 3,
wherein a difference between a thermal expansion coefficient of the deformable body and a thermal expansion coefficient of the adhesive layer is 4.0 ppm/K or less.

5. The load detecting device according to claim 4,
wherein a difference between a thermal expansion coefficient of the deformable body and the thermal expansion coefficient of the adhesive layer is 4.0 ppm/K or less.

6. The load detecting device according to claim 1,
wherein the adhesive layer has a Young's modulus of 70 GPa or greater.
